(19) United States
(12) Patent Application Publication
(10) Pub. No.: US 2025/0170516 A1
(43) Pub. Date: May 29, 2025

(54) CARBON DIOXIDE RECOVERY SYSTEM

(71) Applicant: DENSO CORPORATION, Kariya-city (JP)

(72) Inventors: Yuki FUJITA, Kariya-city (JP); Shohei TANIGUCHI, Kariya-city (JP); Hironori TATSUMI, Kariya-city (JP); Hiroki TAKEZAKI, Kariya-city (JP); Eiichi HIROSE, Kariya-city (JP); Yoshiki MORIOKA, Kariya-city (JP)

(21) Appl. No.: 18/921,051

(22) Filed: Oct. 21, 2024

(30) Foreign Application Priority Data
Nov. 29, 2023 (JP) 2023-201589

(51) Int. Cl. B01D 53/04; B01D 53/14; B01D 53/32

(52) U.S. Cl. CPC B01D 53/0407; B01D 53/1475; B01D 53/326; B01D 2257/504

(57) ABSTRACT

A carbon dioxide recovery system includes an electrochemical cell that includes a working electrode, a counter electrode, an insulating layer, and an electrolyte layer. The electrochemical cell is configured to repeat an adsorption mode and a desorption mode. In the adsorption mode, in a state where oxygen is supplied together with a gas to be treated that contains carbon dioxide to a portion of the electrolyte layer in a vicinity of the working electrode, a voltage is applied between the working electrode and the counter electrode to supply electrons to the working electrode so that the oxygen receives electrons to generate active oxygen, and the active oxygen combines with the carbon dioxide to absorb the carbon dioxide and generate a carbon dioxide adsorbed molecule.

### CROSS REFERENCE TO RELATED APPLICATION

The present application claims the benefit of priority from Japanese Patent Application No. 2023-201589 filed on Nov. 29, 2023. The entire disclosure of the above application is incorporated herein by reference.

### TECHNICAL FIELD

The present disclosure relates to a carbon dioxide recovery system.

### BACKGROUND

There has been known a carbon dioxide recovery system including an electrochemical cell equipped with a working electrode and a counter electrode.

### SUMMARY

A carbon dioxide recovery system according to an aspect of the present disclosure includes an electrochemical cell. The electrochemical cell includes a working electrode configured to come in contact with a gas to be treated that contains carbon dioxide, a counter electrode, and an insulating layer and an electrolyte layer disposed between the working electrode and the counter electrode. The electrochemical cell is configured to repeat an adsorption mode and a desorption mode. The adsorption mode is a mode in which a first voltage is applied between the working electrode and the counter electrode to supply electrons to the working electrode and cause the working electrode to adsorb the carbon dioxide in the gas to be treated. The desorption mode is a mode in which a second voltage different from the first voltage is applied between the working electrode and the counter electrode to emit electrons from the working electrode and desorb and discharge the carbon dioxide from the working electrode. The electrochemical cell is configured such that, in the adsorption mode, in a state where oxygen is supplied together with the carbon dioxide to a portion of the electrolyte layer in a vicinity of the working electrode, a voltage is applied between the working electrode and the counter electrode to supply electrons to the working electrode so that the oxygen receives electrons to generate active oxygen, and the active oxygen combines with the carbon dioxide to absorb the carbon dioxide and generate a carbon dioxide adsorbed molecule.

### BRIEF DESCRIPTION OF DRAWINGS

Objects, features and advantages of the present disclosure will become apparent from the following detailed description made with reference to the accompanying drawings. In the drawings:

FIG. 1 is a block diagram of a carbon dioxide recovery system according to a first embodiment;

FIG. 2 is a perspective view of a carbon dioxide (CO₂) recovery device according to the first embodiment;

FIG. 3 is a cross-sectional view of an electrochemical cell according to the first embodiment;

FIG. 4A is a diagram illustrating an adsorption mode of the CO₂ recovery device according to the first embodiment;

FIG. 4B is a diagram illustrating a desorption mode of the CO₂ recovery device according to the first embodiment;

FIG. 5 is a schematic diagram of an electrochemical cell in the adsorption mode according to the first embodiment;

FIG. 6 is a schematic diagram of a three-phase interface of a working electrode according to the first embodiment; and

FIG. 7 is a schematic diagram of the electrochemical cell in the desorption mode according to the first embodiment.

### DETAILED DESCRIPTION

In a carbon dioxide recovery system, a CO₂ adsorbent material that adsorbs carbon dioxide may be fixed to a working electrode. However, there is a limit to the amount of CO₂ adsorbent material that can be fixed to the working electrode. Therefore, a carbon dioxide recovery capacity is rate-limited by the amount of CO₂ adsorbent material that is fixed. As a result, the carbon dioxide recovery system has room for improvement in terms of carbon dioxide recovery capacity.

A carbon dioxide recovery system according to an aspect of the present disclosure includes an electrochemical cell. The electrochemical cell includes a working electrode configured to come in contact with a gas to be treated that contains carbon dioxide, a counter electrode, and an insulating layer and an electrolyte layer disposed between the working electrode and the counter electrode. The electrochemical cell is configured to repeat an adsorption mode and a desorption mode. The adsorption mode is a mode in which a first voltage is applied between the working electrode and the counter electrode to supply electrons to the working electrode and cause the working electrode to adsorb the carbon dioxide in the gas to be treated. The desorption mode is a mode in which a second voltage different from the first voltage is applied between the working electrode and the counter electrode to emit electrons from the working electrode and desorb and discharge the carbon dioxide from the working electrode. The electrochemical cell is configured such that, in the adsorption mode, in a state where oxygen is supplied together with the carbon dioxide to a portion of the electrolyte layer in a vicinity of the working electrode, a voltage is applied between the working electrode and the counter electrode to supply electrons to the working electrode so that the oxygen receives electrons to generate active oxygen, and the active oxygen combines with the carbon dioxide to absorb the carbon dioxide and generate a carbon dioxide adsorbed molecule.

In the carbon dioxide recovery system, the electrochemical cell is configured to adsorb the carbon dioxide by combining active species of oxygen supplied to the working electrode with the carbon dioxide, as described above. In other words, the active oxygen generated in the portion of the electrolyte layer in the vicinity of the working electrode adsorbs the carbon dioxide. Therefore, a greater amount of carbon dioxide can be recovered. As a result, the carbon dioxide recovery capacity can be improved.

As described above, according to the above aspect, it is possible to provide a carbon dioxide recovery system capable of improving the carbon dioxide recovery capacity.

### First Embodiment

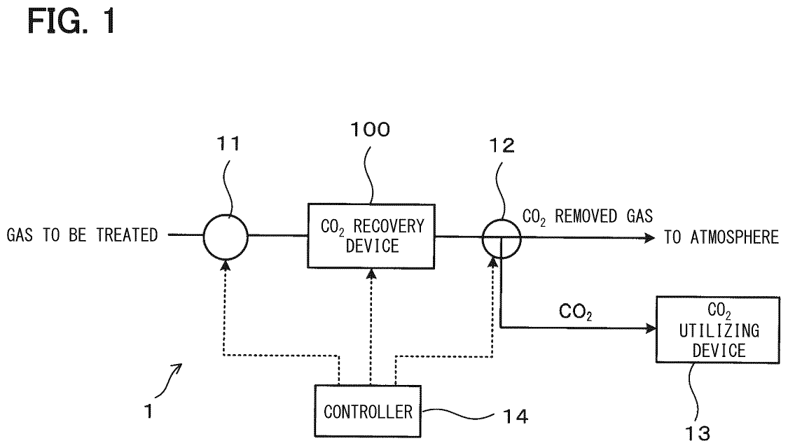

Carbon dioxide recovery systems according to embodiments of the present disclosure will be described with reference to FIGS. 1 to 7. A carbon dioxide recovery system 1 according to a first embodiment is a system that separates carbon dioxide (CO₂) from a gas to be treated that contains carbon dioxide by electrochemical reactions.

As shown in FIGS. 1 to 3, the carbon dioxide recovery system 1 includes an electrochemical cell 101. The electrochemical cell 101 includes a working electrode 102 configured to be in contact with the gas to be treated, a counter electrode 103, an insulating layer 104, and an electrolyte layer 106. The insulating layer 104 and the electrolyte layer 106 are disposed between the working electrode 102 and the counter electrode 103. The working electrode 102 and the counter electrode 103 are disposed opposite to each other with the insulating layer 104 and the electrolyte layer 106 interposed therebetween.

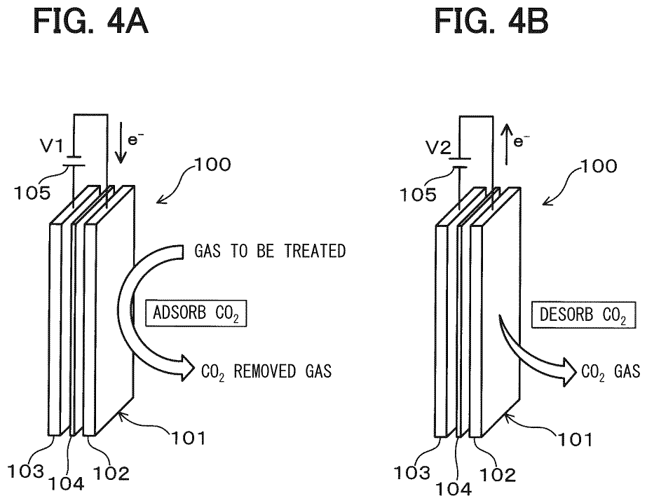

The carbon dioxide recovery system 1 is configured to repeat an adsorption mode shown in FIG. 4A and a desorption mode shown in FIG. 4B. The adsorption mode is a mode in which a first voltage V1 is applied between the working electrode 102 and the counter electrode 103 to supply electrons to the working electrode 102, thereby causing the working electrode 102 to adsorb carbon dioxide in the gas to be treated. The desorption mode is a mode in which a second voltage V2 different from the first voltage V1 is applied between the working electrode 102 and the counter electrode 103 to emit electrons from the working electrode 102 and desorb and discharge carbon dioxide from the working electrode 102.

The electrochemical cell 101 is configured such that, in the adsorption mode, in a state where oxygen is supplied to a portion of the electrolyte layer 106 in the vicinity of the working electrode 102 together with carbon dioxide, a voltage is applied between the working electrode 102 and the counter electrode 103 to supply electrons to the working electrode 102. As a result, oxygen receives electrons to generate active oxygen, which then combines with carbon dioxide to generate carbon dioxide adsorbed molecules, thereby adsorbing carbon dioxide.

The carbon dioxide adsorbed molecule may be, for example, carbonate ion (CO₃²⁻). In the present embodiment, the carbon dioxide adsorbed molecules are mainly carbonate ions (CO₃²⁻).

As shown in FIG. 1, the carbon dioxide recovery system 1 includes a compressor 11, a CO₂ recovery device 100, a flow path switching valve 12, a CO₂ utilizing device 13, and a controller 14.

The compressor 11 pumps the gas to be treated to the CO₂ recovery device 100. The gas to be treated is a mixed gas containing CO₂ and a gas other than CO₂. In the present embodiment, the gas to be treated also contains oxygen (O₂). The gas to be treated may be, for example, the atmosphere or the exhaust gas of an internal combustion engine.

The CO₂ recovery device 100 is a device that separates and recovers CO₂ from the gas to be treated. The CO₂ recovery device 100 discharges a CO₂ removed gas after CO₂ has been recovered and removed from the gas to be treated, or discharges the CO₂ recovered from the gas to be treated. The configuration of the CO₂ recovery device 100 will be described in detail later.

The flow path switching valve 12 is a three-way valve that switches a passage of exhaust gas from the CO₂ recovery device 100. When the CO₂ removed gas is discharged from the CO₂ recovery device 100, the flow path switching valve 12 connects the flow path of the exhaust gas to the atmosphere. When CO₂ is discharged from the CO₂ recovery device 100, the flow path switching valve 12 connects the flow path of the exhaust gas to the CO₂ utilizing device 13.

The CO₂ utilizing device 13 is a device that utilizes CO₂. The CO₂ utilizing device 13 may be a storage tank for storing CO₂ or a conversion device for converting CO₂ into fuel. As the conversion device, a device that converts CO₂ into a hydrocarbon fuel such as methane can be used. The hydrocarbon fuel may be gaseous fuel at normal temperature and pressure, or may be liquid fuel at normal temperature and pressure.

The controller 14 includes a well-known microcontroller including a central processing device (CPU), a read only memory (ROM), a random access memory (RAM) and the like, and peripheral circuits thereof. The controller 14 performs various calculations and processes based on control programs stored in the ROM, and controls actuations of various devices connected to an output side of the controller 14. The controller 14 of the present embodiment performs an operation control of the compressor 11, an operation control of the CO₂ recovery device 100, a passage switching control of the flow path switching valve 12 and the like.

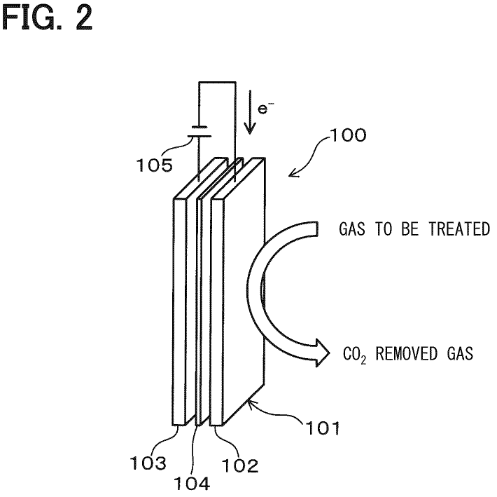

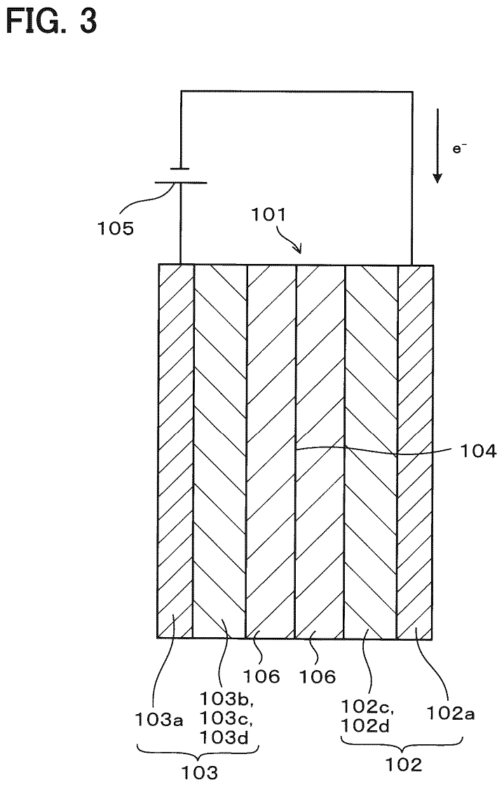

Next, the CO₂ recovery device 100 will be described with reference to FIG. 2. As shown in the FIG. 2, the CO₂ recovery device 100 has the electrochemical cell 101 of an electric field adsorption/desorption type that adsorbs and desorbs CO₂ by electrochemical reactions. The electrochemical cell 101 includes the working electrode 102, the counter electrode 103, and the insulating layer 104. The insulating layer 104 is interposed between the working electrode 102 and the counter electrode 103. In the example shown in FIG. 2, the working electrode 102, the counter electrode 103 and the insulating layer 104 are each formed in a plate shape. Although not shown in FIG. 2, an electrolyte layer 106 is disposed between the working electrode 102 and the counter electrode 103 as shown in FIG. 3. The insulating layer 104 is disposed in the electrolyte layer 106.

The electrochemical cell 101 may be housed in a container (not shown). The container may define a gas inlet for introducing the gas to be treated into the container and a gas outlet for discharging the CO₂ removed gas and CO₂ out of the container.

The CO₂ recovery device 100 is configured to adsorb and desorb CO₂ via electrochemical reactions of the electrochemical cell 101, thereby separating and recovering CO₂ from the gas to be treated. The CO₂ recovery device 100 includes a power source 105 that applies a predetermined voltage to the working electrode 102 and the counter electrode 103, and can change a potential difference between the working electrode 102 and the counter electrode 103. The working electrode 102 is a negative electrode, and the counter electrode 103 is a positive electrode.

As shown in FIG. 4A and FIG. 4B, the electrochemical cell 101 can be operated in a switchable manner between the adsorption mode and the desorption mode by changing the potential difference between the working electrode 102 and the counter electrode 103. The adsorption mode is a mode in which CO₂ is recovered at the working electrode 102. The desorption mode is a mode in which CO₂ is emitted from the working electrode 102. The adsorption mode is a charging mode for charging the electrochemical cell 101, and the desorption mode is a discharging mode for discharging the electrochemical cell 101.

In the adsorption mode, the first voltage V1 is applied between the working electrode 102 and the counter electrode 103, and electrons are supplied to the working electrode 102. At the first voltage V1, (the working electrode potential)<(the counter electrode potential). The first voltage V1 may fall within a range from −0.1 to −5.0 V. The first voltage V1 is expressed as the working electrode potential with respect to the counter electrode potential. The same applies to the second voltage V2. However, when referring to the first voltage V1, the second voltage V2, and the like, “large” and “small” refer to the magnitude of the absolute value.

In the desorption mode, the second voltage V2 is applied between the working electrode 102 and the counter electrode 103, and electrons are supplied to the counter electrode 103. The second voltage V2 is different from the first voltage V1. When (the working electrode potential) (the counter electrode potential), the magnitude relationship between the second voltage V2 and the first voltage V1 is not particularly limited. However, when (the working electrode potential)<(the counter electrode potential), the second voltage V2 is set to be a voltage smaller than the first voltage V1.

As shown in FIG. 3, the working electrode 102 includes a working electrode substrate 102a, and a working electrode conductive assistant 102c and a working electrode binder 102d disposed on the working electrode substrate 102a. In FIG. 3, for convenience, the working electrode conductive assistant 102c and the working electrode binder 102d are illustrated as being arranged on one surface of the working electrode substrate 102a. However, actually, the working electrode conductive assistant 102c and the working electrode binder 102d are disposed inside the working electrode substrate 102a that is porous.

The working electrode substrate 102a is a porous conductive material having pores through which gas containing CO₂ can pass. As the working electrode substrate 102a, for example, a carbonaceous material or a metal material can be used. As the carbonaceous material constituting the working electrode substrate 102a, for example, carbon paper, carbon cloth, non-woven carbon mat, porous gas diffusion layer (GDL) and the like can be used. As the metal material constituting the working electrode substrate 102a, for example, a metal mesh in which a metal (for example, Al, Ni, and the like) is formed into a mesh shape can be used.

The working electrode conductive assistant 102c forms a conductive path protruding from the working electrode substrate 102a into the electrolyte layer 106. It is preferable to use, as the working electrode conductive assistant 102c, a material that has sufficient oxygen activity and is difficult to react with active oxygen. The working electrode conductive assistant 102c may be made of a transition metal, an oxide of a transition metal, a precious metal, or a carbon material. For example, as the working electrode conductive assistant 102c, a carbon material such as carbon nanotube, carbon black and graphene can be used. Alternatively, a transition metal such as Ni, Al, or steel use stainless (SUS) or an oxide thereof can be used as the working electrode conductive assistant 102c. Alternatively, a precious metal such as Pt, Au, or Ag can be used as the working electrode conductive assistant 102c.

The working electrode binder 102d is provided to hold the working electrode conductive assistant 102c to the working electrode substrate 102a. The working electrode binder 102d has adhesive force and is provided between the working electrode conductive assistant 102c and the working electrode substrate 102a.

In the present embodiment, the working electrode conductive assistant 102c and the working electrode binder 102d are used in a mixed state. A mixture of the working electrode conductive assistant 102c and the working electrode binder 102d is formed, and the mixture is bonded to the working electrode substrate 102a.

As the working electrode binder 102d, a conductive resin can be used. The conductive resin may be, for example, an epoxy resin or a fluoropolymer, containing Ag or the like as a conductive filler. The fluoropolymer may be, for example, polytetrafluoroethylene (PTFE), or polyvinylidene fluoride (PVDF).

The counter electrode 103 includes a counter electrode substrate 103a, and an electroactive auxiliary material 103b, a counter electrode conductive assistant 103c, and a counter electrode binder 103d disposed on the counter electrode substrate 103a. In FIG. 3, for the sake of convenience, the electroactive auxiliary material 103b, the counter electrode conductive assistant 103c, and the counter electrode binder 103d are illustrated as being arranged on one surface of the counter electrode substrate 103a. However, actually, the electroactive auxiliary material 103b, the counter electrode conductive assistant 103c, and the counter electrode binder 103d are disposed inside the counter electrode substrate 103a that is porous. The counter electrode substrate 103a, the counter electrode conductive assistant 103c, and the counter electrode binder 103d can have the same structure and material as the working electrode substrate 102a, the working electrode conductive assistant 102c, and the working electrode binder 102d in the working electrode 102, respectively.

As the electroactive auxiliary material 103b, for example, a metal complex that can transfer electrons by changing the valence of the metal ion can be used. Examples of such metal complex include cyclopentadienyl metal complexes such as ferrocene, nickelocene and cobaltocene, and porphyrin metal complexes. These metal complexes may be polymers or monomers.

Also, as the electroactive auxiliary material 103b, organic compounds such as phenothiazine, inorganic compounds such as RuO₂, MnO₂, and MoS₂, and carbon materials such as carbon black and activated carbon can be used.

As the electroactive auxiliary material 103b, for example, a metal complex that can transfer electrons by changing valences of metal ions can be used. Examples of such a metal complex include cyclopentadienyl metal complexes such as ferrocene, nickelocene, and cobaltocene, porphyrin metal complexes, and the like. These metal complexes may be polymers or monomers. In the present embodiment, polyvinylferrocene is used as the electroactive auxiliary material 103b. Ferrocene transfers electrons by changing the valence of Fe between divalent an trivalent.

The electroactive auxiliary material 103b is an auxiliary electroactive species that transfers electrons to and from the working electrode 102, and can also be a substance that can donate electrons by changing the valence of the elements in molecule or crystal when a potential is applied. As the electroactive auxiliary material 103b, for example, an oxide of a transition metal from Group 5 to Group 11 of the periodic table can be used. Preferably, the oxides of Cr, Mn, Fe, Co, Ni, Cu, Ru, Mo, Pd, Ag, more preferably the oxides of Cr, Mn, Fe, Ru can be used as the transition metal oxides. Furthermore, the electroactive auxiliary material 103b may have a characteristic of capturing ions (for example, electrolyte ions) in an electrolyte solution during an electrochemical reaction, and not releasing protons into the electrolyte solution during the transfer of electrons.

In the present embodiment, polyvinylferrocene is used as the electroactive auxiliary material 103b. Ferrocene transfers electrons by changing the valence of Fe between divalent an trivalent.

The insulating layer 104 is disposed between the working electrode 102 and the counter electrode 103, and separates the working electrode 102 and the counter electrode 103 from each other. The insulating layer 104 is an insulating ion permeable membrane that prevents physical contact between the working electrode 102 and the counter electrode 103 to restrict an electrical short circuit and that allows ions to permeate therethrough.

As the insulating layer 104, a separator or a gas layer such as air can be used. In the present embodiment, a porous separator is used as the insulating layer 104. As the material of the separator, a cellulose membrane, a polymer, a composite material of a polymer and a ceramic, or the like can be used.

Between the working electrode 102 and the counter electrode 103, the electrolyte layer 106 having ionic conductivity is provided. The electrolyte layer 106 is disposed between the working electrode 102 and the counter electrode 103. The electrolyte layer 106 is disposed so as to be in contact with the working electrode 102, the counter electrode 103 and the insulating layer 104.

The electrolyte layer 106 may be made of an ionic liquid, a solid electrolyte, or the like. The ionic liquid is a salt of a liquid having non-volatility under normal temperature and pressure. When the ionic liquid is used as the electrolyte layer 106, the ionic liquid may be gelled to prevent elution of the ionic liquid from the electrochemical cell 101. When the solid electrolyte is used as the electrolyte layer 106, it is preferable to use an ionomer made of a polymer electrolyte or the like.

Examples of the ionic liquid include 1-ethyl-3-methylimidazolium bis (trifluoromethanesulfonyl) imide ([EMIM][Tf₂N]), 1-butyl-3-methylimidazolium bis (trifluoromethanesulfonyl) imide ([BMIM][Tf₂N]), 1-butyl-3-methylimidazolium tetrafluoroborate ([BMIM][BF₄]), 1-ethyl-1-propylpyrrolidinium=bis (trifluoromethylsulfonyl) imide, N, N, N-trimethyl-N-propylammonium bis (trifluoromethanesulfonyl) imide, 1-ethyl-3-methylimidazolium tetrafluoroborate, 1-butyl-1-methylpyrrolidinium=bis(trifluoromethanesulfonyl) imide, and the like.

Alternatively, H₂SO₄, Na₂SO₄, KOH or the like can be used as the material of the electrolyte layer 106.

The electrolyte layer 106 preferably has a lower solubility of carbon dioxide than of oxygen. Here, the solubility is calculated as the molar amount of carbon dioxide or oxygen, which is a solute, relative to the molar amount of the electrolyte material, which is a solvent.

From this viewpoint, it is particularly preferable to use, for example, trimethylpropylammonium bis(trifluoromethanesulfonyl)imide) (TMPATFSI) or 1-butyl-3-methylimidazolium bis(trifluoromethylsulfonyl) imide (BIMITFST) as the electrolyte layer 106. The solubility of carbon dioxide and the solubility of oxygen in the electrolyte layer 106 are also affected by the partial pressures of carbon dioxide and oxygen in the gas to be treated. Therefore, in order to realize the relationship of (the solubility of carbon dioxide)<(the solubility of oxygen), it is desirable that the partial pressure of carbon dioxide is not too high and the partial pressure of oxygen is not too low.

Next, the operation of the carbon dioxide recovery system 1 of the present embodiment will be described with reference to FIGS. 4A to 7.

The carbon dioxide recovery system 1 operates by alternately switching between the adsorption mode shown in FIG. 4A and the desorption mode shown in FIG. 4B. The operation of the carbon dioxide recovery system 1 is controlled by the controller 14.

First, the adsorption mode will be described. In the adsorption mode, the compressor 11 operates to supply the gas to be treated to the CO₂ recovery device 100. In the CO₂ recovery device 100, the voltage applied between the working electrode 102 and the counter electrode 103 is set to the first voltage V1. Accordingly, the electroactive auxiliary material 103b of the counter electrode 103 emits electrons to be oxidized, and the electrons are supplied from the power source 105 to the working electrode 102.

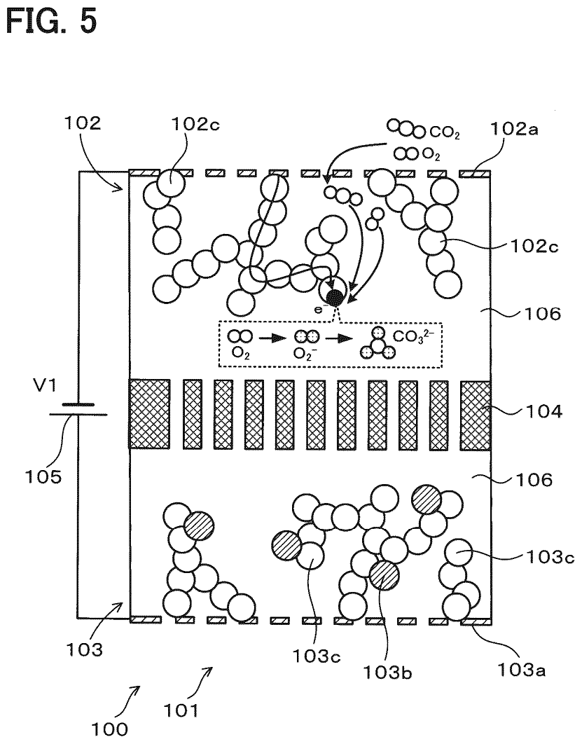

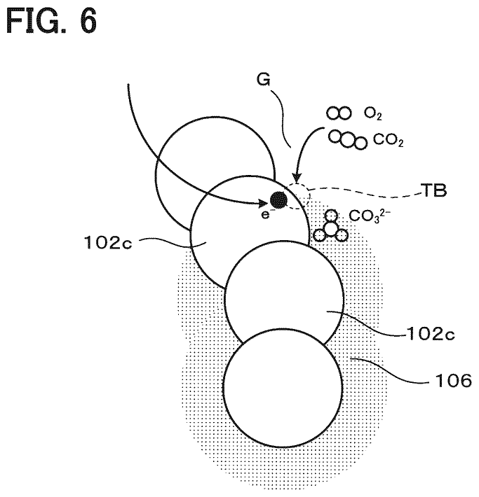

As shown in FIG. 5 and FIG. 6 the electrons supplied to the working electrode 102 move through the working electrode conductive assistant 102c to a three-phase interface TB between the working electrode conductive assistant 102c, the electrolyte layer 106, and the gas G to be treated. At the three-phase interface TB, oxygen (O₂) contained in the gas G to be treated receives electrons (e⁻) from the working electrode conductive assistant 102c and becomes active oxygen (O₂⁻). In other words, active oxygen is generated at the three-phase interface TB. This active oxygen combines with carbon dioxide (CO₂) in the gas G to be treated, and carbon dioxide is adsorbed in the vicinity of the working electrode 102. In this state, carbon dioxide (CO₂) is adsorbed in the vicinity of the working electrode 102 in a state in which carbon dioxide combines with active oxygen (O₂⁻) to form carbonate ions (CO₃²⁻).

To be precise, CO₂ is adsorbed by active oxygen in the electrolyte layer 106 in the vicinity of the working electrode 102 (more specifically, the working electrode conductive assistant 102c). However, it can also be considered that CO₂ is substantially adsorbed on the working electrode 102. Therefore, in the present specification, this state, that is, the state in which carbon dioxide is adsorbed to active oxygen in the vicinity of the working electrode 102, will also be expressed as “adsorbed to the working electrode.”

As shown in FIG. 6, the three-phase interface TB is formed, for example, between a part of the electrolyte layer 106 attached to the working electrode conductive assistant 102c, the working electrode conductive assistant 102c, and the gas G to be treated.

In the adsorption mode, it is preferable that there is a time period during which a supply rate of carbon dioxide to the working electrode 102 is greater than a generation rate of active oxygen at the working electrode 102. To achieve this condition, for example, the first voltage V1 is adjusted so that the current value supplied to the electrochemical cell 101 is set to a sufficiently small value. The comparison between the supply rate of carbon dioxide and the generation rate of active oxygen at the working electrode 102 is made in terms of the number of moles per unit time. The time period during which the supply rate of carbon dioxide to the working electrode 102 is greater than the generation rate of active oxygen at the working electrode 102 may be the entirety of the adsorption mode or may be a part of the adsorption mode.

After carbon dioxide is removed from the gas to be treated in the CO₂ recovery device 100 in the adsorption mode, and the gas to be treated is discharged from the CO₂ recovery device 100 as the CO₂ removed gas. In the adsorption mode, the flow path switching valve 12 connects the gas flow path to the atmosphere, and the CO₂ removed gas discharged from the CO₂ recovery device 100 is discharged to the atmosphere (see FIG. 1).

The time of each adsorption mode is shorter than the diffusion time of carbonate ions (that is, carbon dioxide adsorbed molecules) generated at the working electrode 102 to the counter electrode 103. The “diffusion time of the carbonate ions generated at the working electrode 102 to the counter electrode 103” can be calculated, for example, from Fick's equation using the concentration of carbonate ions generated at the working electrode 102, the distance between the working electrode 102 and the counter electrode 103, and the carbonate ion diffusion coefficient in the electrolyte.

Next, the desorption mode will be described. In the desorption mode, the compressor 11 stops operating, and the supply of the gas to be treated to the CO₂ recovery device 100 stops.

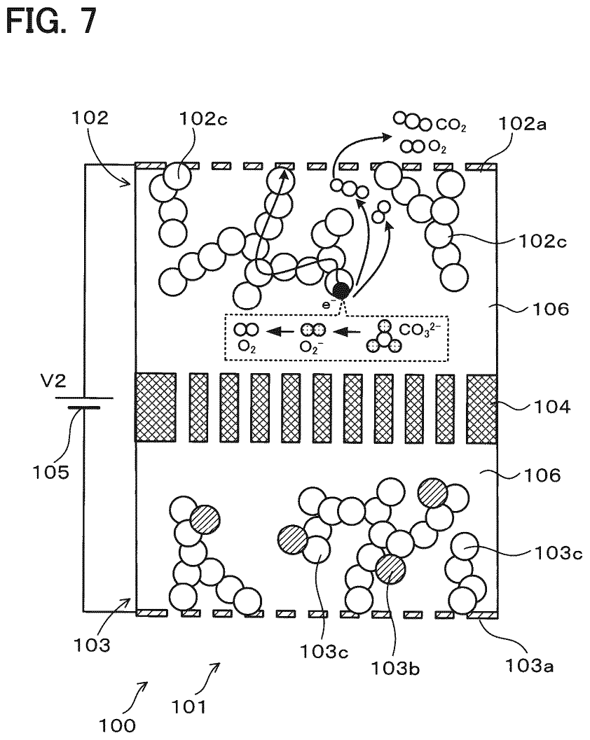

As shown in FIG. 4B and FIG. 7, in the CO₂ recovery device 100, the voltage applied between the working electrode 102 and the counter electrode 103 is set to the second voltage V2. Accordingly, the electroactive auxiliary material 103b of the counter electrode 103 receives electrons from the power source 105 to be reduced.

As shown in FIG. 7, the working electrode 102 emits electrons. Accordingly, the CO₂ that has been adsorbed to the working electrode 102 by electrostatic interaction is desorbed from the working electrode 102.

The CO₂ emitted from the working electrode 102 is discharged from the CO₂ recovery device 100. In the desorption mode, the flow path switching valve 12 connects the gas flow path to the CO₂ utilizing device 13, and the CO₂ discharged from the CO₂ recovery device 100 is supplied to the CO₂ utilizing device 13 (see FIG. 1).

The present embodiment provides the following functions and advantages. As described above, the electrochemical cell 101 is configured to adsorb carbon dioxide by combining active species of oxygen supplied to the working electrode 102 with carbon dioxide. That is, the active oxygen generated in a portion of the electrolyte layer 106 in the vicinity of the working electrode 102 adsorbs the carbon dioxide.

In other words, the carbon dioxide is not directly adsorbed onto the surface of the working electrode 102, but is adsorbed onto the active oxygen generated in the portion of the electrolyte layer 106 in the vicinity of the working electrode 102, so that the adsorption area can be dramatically increased. Therefore, a greater amount of carbon dioxide can be recovered. As a result, the carbon dioxide recovery capacity can be improved.

Moreover, in the carbon dioxide recovery system 1, both adsorption and desorption of carbon dioxide are carried out at the working electrode 102. That is, the gas to be treated is supplied to the working electrode 102 to cause the working electrode 102 to adsorb carbon dioxide, and the carbon dioxide is discharged from the working electrode 102 to the CO₂ utilizing device 13. In other words, carbon dioxide is recovered by the working electrode 102 and discharged from the working electrode 102. This eliminates the need to transfer the recovered carbon dioxide from the working electrode 102 to the counter electrode 103. Therefore, the efficiency of recovering carbon dioxide is not limited by the diffusion rate of carbonate ions in the electrolyte layer 106. As a result, the carbon dioxide recovery capacity can be improved.

As described above, the carbon dioxide recovery system 1 of the present embodiment adsorbs carbon dioxide to the working electrode 102 and discharges the carbon dioxide from the working electrode 102 to the CO₂ utilizing device 13. Therefore, a supply flow path for supplying the gas to be treated and an exhaust flow path for exhausting the CO₂ gas and the CO₂ removed gas are provided adjacent to the working electrode 102, and there is no need to provide them adjacent to the counter electrode 103. Therefore, the carbon dioxide recovery system 1 can be easily made smaller and simpler.

The time of each adsorption mode is shorter than the diffusion time of carbonate ions (that is, carbon dioxide adsorbed molecules) generated at the working electrode 102 to the counter electrode 103. Therefore, the carbon dioxide adsorbed on the working electrode 102 can be efficiently discharged from the working electrode 102 to the CO₂ utilizing device 13 in the desorption mode. In other words, in the adsorption mode, as described above, carbonate ions are formed in the portion of the electrolyte layer 106 in the vicinity of the working electrode 102, thereby adsorbing carbon dioxide. However, it is considered that the carbonate ions diffuse through the electrolyte layer 106 and some of them move toward the counter electrode 103. When the carbonate ions diffuse to the counter electrode 103, the amount of recovered carbon dioxide decreases. Therefore, the time of each of the adsorption modes is set shorter than the diffusion time of carbonate ions generated at the working electrode 102 to the counter electrode 103.

From this viewpoint, it is more preferable that the time for each of the adsorption modes is 1/10 or less of the diffusion time of the carbonate ions generated at the working electrode 102 to the counter electrode 103.

On the other hand, in the adsorption mode, it is necessary to ensure a sufficient time for carbon dioxide to be adsorbed sufficiently. For example, it is desirable to set the time to be longer than the time required for the capacitor component formed by the working electrode 102 and the counter electrode 103 to be charged.

In addition, in the adsorption mode, there is a time period during which the supply rate of carbon dioxide to the working electrode 102 is greater than the generation rate of active oxygen at the working electrode 102. This makes it possible to restrict excessive generation of active oxygen, and to restrict deterioration of the working electrode 102 and decrease in energy efficiency.

The working electrode conductive assistant 102c is made of the transition metal, the oxide of the transition metal, the precious metal, or the carbon material. This makes it possible to efficiently generate active oxygen and restrict deterioration of the working electrode 102.

In the electrolyte layer 106, the solubility of carbon dioxide is smaller than the solubility of oxygen. This allows sufficient active oxygen to be generated in the vicinity of the working electrode 102. As a result, the amount of recovered carbon dioxide can be effectively improved.

As described above, according to the above aspect, it is possible to provide a carbon dioxide recovery system capable of improving the carbon dioxide recovery capacity.

The present disclosure is not limited to each of the above embodiments, and can be applied to various embodiments without departing from the gist thereof.

What is claimed is:

1. A carbon dioxide recovery system comprising
an electrochemical cell including a working electrode configured to come in contact with a gas to be treated that contains carbon dioxide, a counter electrode, and an insulating layer and an electrolyte layer disposed between the working electrode and the counter electrode, wherein
the electrochemical cell is configured to repeat an adsorption mode and a desorption mode,
the adsorption mode is a mode in which a first voltage is applied between the working electrode and the counter electrode to supply electrons to the working electrode and cause the working electrode to adsorb the carbon dioxide in the gas to be treated,
the desorption mode is a mode in which a second voltage different from the first voltage is applied between the working electrode and the counter electrode to emit electrons from the working electrode and desorb and discharge the carbon dioxide from the working electrode, and
the electrochemical cell is configured such that, in the adsorption mode, in a state where oxygen is supplied together with the carbon dioxide to a portion of the electrolyte layer in a vicinity of the working electrode, a voltage is applied between the working electrode and the counter electrode to supply electrons to the working electrode so that the oxygen receives electrons to generate active oxygen, and the active oxygen combines with the carbon dioxide to absorb the carbon dioxide and generate a carbon dioxide adsorbed molecule.

2. The carbon dioxide recovery system according to claim 1, wherein
a time of the adsorption mode is shorter than a diffusion time of the carbon dioxide adsorbed molecule that is generated at the working electrode to the counter electrode.

3. The carbon dioxide recovery system according to claim 1, wherein
in the electrolyte layer, a solubility of carbon dioxide is lower than a solubility of oxygen.

4. The carbon dioxide recovery system according to claim 1, wherein
the working electrode includes a working electrode substrate and a working electrode conductive assistant disposed on the working electrode substrate, and
the electrochemical cell has a three-phase interface between the working electrode conductive assistant, the electrolyte layer, and the gas to be treated.

5. The carbon dioxide recovery system according to claim 4, wherein
the working electrode conductive assistant is made of a transition metal, an oxide of a transition metal, a noble metal, or a carbon material.

6. The carbon dioxide recovery system according to claim 1, wherein
the adsorption mode includes a time period during which a supply rate of the carbon dioxide to the working electrode is greater than a generation rate of the active oxygen at the working electrode.
